(19) United States
(12) Patent Application Publication
(10) Pub. No.: US 2022/0343442 A1
(43) Pub. Date: Oct. 27, 2022

(54) Web Browser Extension for Generating Graduated Evaluation Metrics Based on Displayed Web Content

(71) Applicant: Homebot, Inc., Denver, CO (US)

(72) Inventors: Ernest Filson Graham, Denver, CO (US); Chad Michael Calhoun, Arvada, CO (US); Michael Patrick Lynch, Boulder, CO (US); Ira Connor McMahon, Denver, CO (US); Sharayah Elise Cook, Denver, CO (US); Carolyn Clark, Evergreen, CO (US); Sean Patrick John Paul George Ringo Doran, Denver, CO (US); Matthew Lee Jongbloet, Denver, CO (US); Callista Anderson Ringsby, Denver, CO (US)

(21) Appl. No.: 17/727,209

(22) Filed: Apr. 22, 2022

Related U.S. Application Data
(60) Provisional application No. 63/178,100, filed on Apr. 22, 2021.

(51) Int. Cl. G06Q 50/16; G06F 21/31

(52) U.S. Cl. CPC G06Q 50/16; G06F 21/31

(57) ABSTRACT

Embodiments include computer implemented methods for generating a real-time personalized graduated evaluation metric associated with listings being displayed in a web browser. A user account can be authenticated by sending a set of login credentials to an authentication server and receiving an authentication token including user information. Web-based content can be displayed in the web browser application to determine that the web-based content corresponds to a listing page. A purchase metric can be generated for the listing based on a first set of listing data, a second set of listing data obtained using the first set of listing data, and the user information. A graduated evaluation metric can be selected based on the purchase metric satisfying a threshold associated with a first graduated evaluation metric and causing a web browser application to display a popup window containing a graduated visual indicia corresponding to the graduated evaluation metric.

### CROSS-REFERENCE TO RELATED APPLICATION

This application is a nonprovisional of, and claims the benefit under 35 U.S.C. § 119(e) of, U.S. Provisional Patent Application No. 63/178,100, filed Apr. 22, 2021, the contents of which are incorporated herein by reference as if fully disclosed herein.

### FIELD

The described embodiments relate generally to methods, processes, and systems for a browser extension that generates graduated evaluation metrics based on displayed web content. More particularly, the embodiments relate to processes for operating a web browser extension to automatically determine and display an adaptive graduated evaluation metric for a currently displayed web listing.

### BACKGROUND

Websites can display webpages or other web content for various types of listings. A user browsing the web content may compare different purchasing options using the information displayed on the webpage. However, current web browser systems are unable to compute a real-time evaluation metric that is computed based on information obtained about the user, information about the listing, and other resources that may not be available to the user while browsing the web. The systems and techniques described herein are directed to a web browser extension that solves some of the deficiencies with current web browser solutions.

### SUMMARY

Embodiments are directed to computer implemented methods for generating a real-time personalized graduated evaluation metric associated with listings being displayed in a web browser application. The computer implemented method can include operating a browser extension in the web browser application to perform one or more steps of the methods. The methods can include authenticating a user account by sending a set of login credentials to an authentication server and receiving an authentication token associated with the set of login credentials, where the authentication token can include first user information associated with the user account. Embodiments can also include analyzing a uniform resource locator to determine a content classifier. In accordance with a determination that the content classifier corresponds to a listing page, methods can include obtaining a first set of listing data by parsing a second set of text fields of the web-based content, where the first set of listing data can include a listing price and listing address. The first set of listing data can be used to retrieve a second set of listing data from one or more databases, where the second set of listing data can include loan information associated with a real estate item referenced on the listing. Methods can include generating a purchase metric for the listing based on the first set of listing data, the second set of listing data, and the first set of user information and selecting a graduated evaluation metric from a set of graduated evaluation metrics, where each evaluation metric in the set of graduated evaluation metrics is associated with a respective threshold range. Methods can also include selecting the graduated evaluation metric based on the purchase metric satisfying the respective threshold of the first graduated evaluation metric. Methods also include causing the web browser application to display a popup window containing a graduated visual indicia corresponding to the graduated evaluation metric.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an example network system for generating real-time adaptive purchase analyses for property listings;

FIG. 2 shows an example process flow for determining that a user is viewing a property listing and generating a real-time adaptive purchase analysis;

FIG. 3 shows an example web browser interface for providing a real-time adaptive purchase analysis;

FIG. 4 shows an example web browser interface for providing a real-time adaptive purchase analysis;

FIG. 5 shows an example process flow for generating real-time adaptive purchase analyses for a property listing;

FIGS. 6A-6D show examples of web browser interfaces for providing real-time adaptive purchase analysis;

FIG. 7 shows an example web browser interface for displaying multiple saved adaptive purchase analyses for a property listing;

FIG. 8 shows an example web browser interface for displaying multiple saved adaptive purchase analyses for a property listing; and

FIG. 9 shows an example electrical block diagram for an electronic device that may perform the operations described herein.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Embodiments disclosed herein are directed to systems and methods for generating real-time adaptive purchase analyses for web content displayed in a web browser application. The system can include a browser extension that interfaces with a web browser application. The browser extension can operate to authenticate a user account and receive and transmit information about the user account to a server. For example, the browser extension can transmit authentication credentials to the server, and in response to the server verifying the credentials, the server can send an authentication token to the browser extension. After authenticating a user account, the browser extension can be configured to analyze webpage information to make a determination as to whether the web browser application is displaying listing information associated with a property. For example, the browser extension can parse a uniform resource locator (URL) for a current webpage and compare the URL information to a database of real estate listing sites. Additionally or alternatively, the browser extension can scrape content displayed on the webpage and analyze the content to determine whether the webpage is displaying a property associated with a real estate listing (e.g., whether the webpage is a web-based property page). This can include analyzing metadata associated with the webpage, text, images, and other suitable information.

As used herein, the term real estate listing is intended to cover information about a property that is for sale or rent and exchanged through a private offering service. The term real estate listing may refer to information about a property for sale or rent that is listed on a public or private real estate site such as a multiple listing service (MLS). The real estate listing can include information about a particular property such as its location, offering price, size of a dwelling, number of bedrooms, number of bathrooms, and so on. In some cases, the term real estate listing also applies to properties that are being offered for rent, lease, or through some other contractual agreement. As used herein, the term property summary page is intended to cover other services, such as web-based services, that provide information about a property that is offered for sale or rent, which can include a property listed on a real estate listing service. In some cases, a property summary page displays information about one or more properties on a website, the property summary page can include information obtained from the real estate listing and/or other sources.

Traditionally, many websites do not have direct access to certain types of information or data associated with a user viewing the website. For example, a website does not typically have automatic access to a user's financial data, which can include data that is subject to one or more privacy restrictions. Moreover, it can be risky for a user to share or grant a website access to their financial data as the user is relying on that particular web-based content provider to secure and ensure that their financial data remains private. In relation to a user viewing a website containing a property listing, the web content provided to a user's browser may contain information about the property such as cost, location, number of bedrooms and bathrooms, information about the lot size, and so on. However, there may not be a way for the website to securely pull accurate private data for the user, especially where the data includes financial or other data that is subject to privacy restrictions and/or is otherwise considered sensitive.

The browser extension described herein allows a user to keep their private data secure and only accessible through an authentication scheme while being able to use this data to evaluate a wide range of publicly available web content. For example, the browser extension described here can securely use a user's private data such as personal financial information to generate a personalized financial evaluation of a listed property that is being displayed on a property summary page. The browser extension can pull accurate data from multiple resources and securely combine it with a user's personal financial data to generate a personalized recommendation or personalized information relating to the property displayed on a website. The personalized analysis can be presented to the user in an evaluation that is graduated along an easy-to-understand scale that indicates a net level of positivity, negativity, or neutrality with respect to a particular user and a purported transaction. The browser extension can be leveraged to maintain a user's personal data, such as their financial data, personally identifiable information, or other potentially sensitive data and may be subject to special handling behind a secure authentication-based firewall or other secure protection scheme. Without the browser extension described herein, a user would need to give each website access to their private information (e.g., financial records) or other personal information in order to receive the personalized analyses described herein, which would expose the user to a greater risk of fraud, data breach or other loss of their sensitive personal and financial information.

In some cases, a user's personal data can include their browsing history, such as a particular property summary pages that a user viewed and/or information associated with a listed property that was saved to a user's account. This personal information can be saved and/or otherwise associated with the user's account and controlled by the user. In some cases, this information can include data related to a listed property that spans more than a single listing site, for example, if a user viewed properties on multiple different listing sites. In some cases, it can include click data or other interaction data with a property listing, such as the amount of time viewing a listing, and so on. In some cases, the browser extension can use this data and securely combine it with a user's personal information to generate a personalized recommendation or information relating to information displayed on a website.

The browser extension can be configured to automatically generate a personalized evaluation/recommendation based on detecting that the web browser is currently displaying a property listing. For example, in response to a browser being navigated to a URL or other network location endpoint, the browser extension may automatically obtain data associated with the URL and perform the analysis and recommendations, described herein. Additionally, the browser extension may be adapted to convert data associated with the URL and generate a uniform or normalized data object that may be used by the analysis engine associated with the plugin. Specifically the data associated with the URL may include HTML or other markup language data, metadata, or other data formatted for viewing or access using a traditional browser application. In response to a navigation event or action, the plugin may automatically extract particular data associated with the URL and convert or normalize the data in accordance with a data schema associated with the analysis engine used by the plugin. The data schema may be stored as a JSON file, XML, or other similar format with a schema defined by the system described herein. The normalization may allow the extracted data to be combined with other data sources and used to generate a personalized evaluation for the property listing associated with the URL. In some cases, detecting the presences of property listing and retrieving listing data from the listing page can cause the browser extension to display an interface element on the webpage. The interface element can indicate that an adaptive purchase analysis for the listed property has been performed and can be viewed by the user. Accordingly, in response to web browser application identifying that a specific type of content (e.g., listing data) is being displayed, the systems described herein can automatically obtain data from the listing page that is adapted for use by a web browser application and convert or normalize the data to conform with a predefined schema, which can be used to generate and display an personalized adaptive purchase analysis.

In response to determining that the web browser is currently displaying a property listing and/or performing the adaptive purchase analysis, the browser extension can be configured to display a selectable user interface element that is associated with the property listing. The selectable user interface element can be used to display an adaptive purchase analysis for the property listing or indicate that an adaptive purchase analysis was performed and is available for viewing. The adaptive purchase analysis can be based on data associated with the real estate website and data retrieved from other sources such as one or more external databases. For example, the browser extension may use information from the real estate listing site to retrieve data related to a listed property displayed on a property summary page.

In some cases, only transient data from a property summary page is used without needing to save any data from the associated website. For example, the browser extension can analyze a URL, and access metadata associated with the property summary page without needing to save data and use that information to retrieve additional details about the listed property for one or more other sources. In some cases, the browser extension can perform these processes in real-time and thereby any data that is associated with the website is accessed while the website is active in the web browser application, but not otherwise saved or downloaded. For example, the browser extension can determine an address associated with a listed property shown on a property summary page and can use that address information from one or more independent public or private data sources. In this regard the address can be used to retrieve a listing price, a listing image, among other data from a different source.

In some cases, the browser extension may save a URL associated with a property listing and/or other web-based data, and not save other information that is presented on the property listing site. Additional information about the property displayed on the property listing can be accessed using other public and private sources such as a MLS database. The browser extension can transmit this data to an analysis server, where the adaptive purchase analysis can be performed. The analysis server can retrieve additional data for performing the adaptive purchase analysis. For example, the analysis server can access one or more secure databases that include information about the particular user. In some cases, these databases can be populated with information obtained from the user during a prior interaction, for example, when a user sets up their user account. The secure databases can include information about a current address of a user and use that data to estimate a user's current monthly mortgage payment. The user information may, in some instances, include financial data including, but not limited to, estimated savings, estimated monthly or yearly earnings, assets, estimated debt, and estimated expenses. If the user is a renter, the internal database can include information about the user's rental agreement such as their rent cost, lease expiration, and so on.

In some cases, the analysis server can use the information about the property listing to retrieve additional data such as lien data, loan amount, origination data, loan rate, and/or the like. The analysis server can also access other external data sources to retrieve information related to the selling history of the property associated with the listing, a current estimated value, recent sale data, and so on. Using the retrieved data, the analysis server can perform the adaptive purchase analysis based on retrieved data that is specific to the user account. For example, the adaptive purchase analysis can include estimating a monthly mortgage for the property associated with the listing and determining a current monthly real estate cost for the user.

Additionally or alternatively, the adaptive purchase analysis can include estimated house maintenance costs, estimated insurance costs, estimated short-term and/or long-term rental income for the associated property, and so on. In cases where the property listing is a rental property, the adaptive purchase analysis can include estimated costs specific to rental agreements such as renters insurance. In some cases, the adaptive purchase analysis can output a purchase metric and use the purchase metric to select a graduated evaluation metric from a set of graduated evaluation metrics. The browser extension can then display a visual indicia of the selected graduated evaluation metric in a pop-up window or other user interface element. The visual indicia can provide an easy-to-understand analysis of the evaluation for the real estate listing such as good, neutral, or bad classification. As used herein, the term “graduated evaluation metric” can represent a distinct value along a predefined scale of progressive value. In some cases, different graduated quality metrics can correspond to a positive, neutral, and negative predefined scale of evaluation. In some cases, values of the progressive scale may correspond to multiple levels of increasing positive evaluation and/or increasing (or decreasing) levels of negative evaluation.

In some cases, multiple graduated evaluation metrics can be defined, each associated with a different purchase recommendation. For example, the analysis server can associate a first graduated evaluation metric with a computed score that indicates that the estimated cost of the property listing is less expensive than the user's current monthly real estate cost. The first graduated evaluation metric can be associated with a positive visual indicia such as a smiley face, thumbs up, specific color, letter, number, or the like. The analysis server can associate a second graduated evaluation metric with a computed score that indicates that the estimated cost of the property listing is within a statistically significant range of the user's current monthly real estate cost. The second graduated evaluation metric can be associated with a neutral visual indicia such as a neutral face, specific color, letter, number, or the like. In other cases, additional graduated evaluation metrics can be defined. The graduated evaluation metrics and their respective visual indicia can serve as an indicator of positivity, neutrality, or negativity with respect to a particular user and a purported transaction, which in this example is a property purchase or property rental.

In response to determining a graduated evaluation metric for the user account for the property listing, the analysis server can send an indication of the visual indicia associated with the graduated evaluation metric to the browser extension to be displayed in conjunction with the property listing. For example, the browser extension can cause a window to be displayed in the web browser, and the window can display the visual indicia associated with the selected graduated evaluation metric. In some cases, the window can display additional information related to the adaptive purchase analysis, such as the estimated monthly mortgage for the property listing and a current monthly real estate cost for the user. Additionally or alternatively, the window can include a breakdown of the adaptive purchase analysis, such as information related to the estimated monthly mortgage, which can include an estimated principal mortgage cost, property tax costs, home insurances costs, estimated mortgage interest cost, estimated maintenance costs, and so on.

In some cases, the analysis server can receive inputs from the user, for example via the user interface in the browser, and generate one or more purchase metrics based on the user inputs. For example, the user can input a monthly budget for housing costs and the analysis server can use the input to compute a purchase recommendation for the user. The analysis server can use the monthly budget along with other metrics such as an estimated down payment, interest rates, an appreciation rate for the property, to determine whether a graduated evaluation metric for purchasing the property. In some cases, if the estimated monthly cost of the property (e.g., mortgage cost, estimated maintenance, taxes, home insurance, and so on) is less than the user's monthly budget, the analysis server may output a positive purchase recommendation. In other cases, if the estimated monthly cost of the property is greater than a user's monthly budget, the analysis server may output a less positive purchase recommendation. In some cases, the purchase recommendation may also be based on other factors such as appreciation of the property over time, a potential gain if the user were to purchase the property and sell after a specific duration (e.g., sell after 5 years), and so on. Accordingly, in some cases, the property costs may be above a set monthly budget, but the system may output a positive purchase recommendation, for example, if there is an overall positive gain from purchasing the property.

The browser extension can display a selectable interface option to save information associated with the property listing to the user's account. In some cases, this information can be used to identify the property listing, the corresponding real estate listing, the property itself, information that was generated as part of the adaptive purchase analysis, or other related information, or a combination thereof. In response to the interface option being selected, the browser extension can save information obtained about the property that is being displayed on the real estate listing site along with the adaptive purchase analysis to one or more internal databases and associate the data with the user account. In some cases, a user can save data associated with multiple different property listings and their corresponding adaptive purchase analyses to their user account. The user can access this saved data from a web interface and/or use the browser extension. In some cases, the web interface and/or browser extension can display multiple saved listings data along with their respective visual indicia associated with the selected graduated evaluation metric, which provides metrics that are personalized based on the specific user. For example, in some cases, the analysis server may generate a different graduated evaluation metric for a different user account for the same real estate listing. In this regard, each graduated evaluation metric can be generated in real-time (e.g., as the user is viewing the listing) and it can be based on a specific user account.

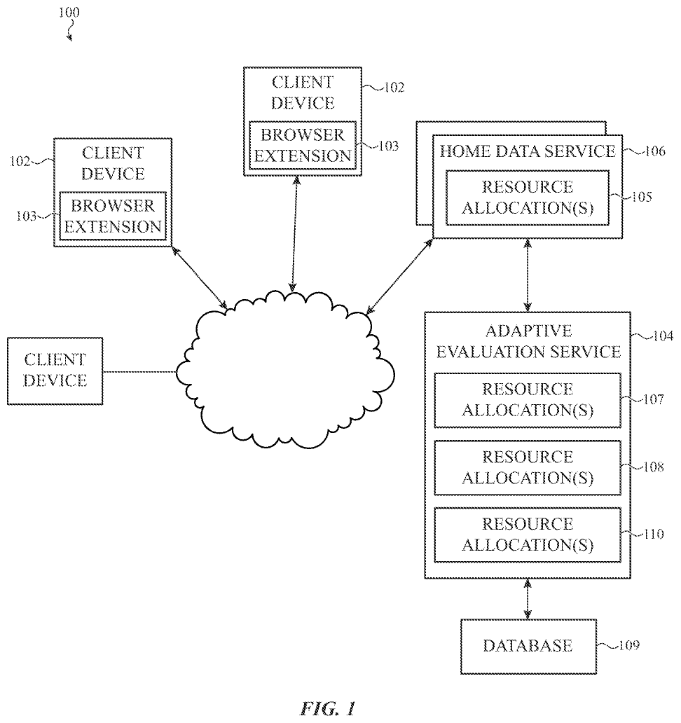

These and other embodiments are discussed below with reference to FIGS. 1-9. However, those skilled in the art will readily appreciate that the detailed description given herein with respect to these Figures is for explanatory purposes only and should not be construed as limiting.

FIG. 1 shows an example network system 100 for generating real-time adaptive purchase analyses for property listings. The network system 100 can be implemented with one or more client devices 102 that communicably couple (e.g., via one or more networking wired or wireless communication protocols) to an adaptive evaluation service 104, and a home data service 106.

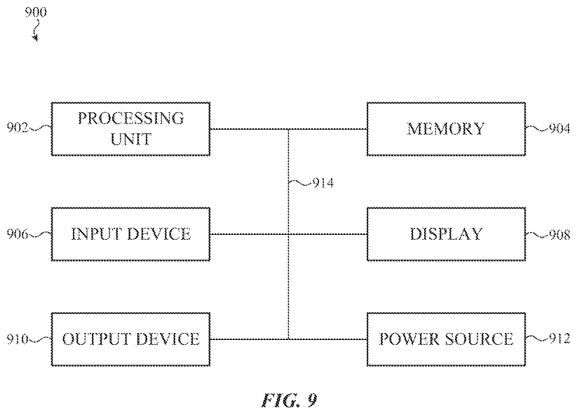

In various embodiments, the network system 100 is configured to operate within or as a virtual computing environment that is supported by one or more physical servers including one or more hardware resources such as, but not limited to (or required to be) one or more of: a processor; a memory; computer-readable memory or other non-volatile storage; networking connection; and the like, such as those in the electrical block diagram 900 described with reference to FIG. 9. It may be appreciated that although these functional elements are identified as separate and distinct devices (e.g., servers) that can each include allocations of physical or virtual resources (identified in the figure as the resource allocations 105 and 107 respectively), such as one or more processors, memory, and/or communication modules (e.g., network connections and the like), such an implementation is not required. The network system 100 can leverage such resources to instantiate a number of discrete subservices or purpose-configured modules, containers, or virtual machines each configured to perform, coordinate, serve, or otherwise provide one or more services, functions, or operations of the network system 100, such as the adaptive evaluation service 104 and/or the home data service 106. The adaptive evaluation service 104 and the home data service 106 may be referred to herein as application platforms or simply platforms, which can reside on the same host server, or in other implementations, they may reside or be provided by a separate or discrete server(s).

The client devices 102 can each be configured with a browser extension 103 that can be used to implement specific functionality in a browser. The browser extension 103 can include executable code that is added to or configured to operate in conjunction with a web browser application to add new functionality to the web browser application. In some cases, the browser extension 103 can include an executable code that is initiated by the web browser application. In some cases, the browser extension 103 is implemented as source code that is executed by or integrated with the web browser application. The browser extension 103 can be configured to perform one or more steps of the adaptive purchase evaluation described herein. The browser extension 103 can also provide a user interface for receiving inputs from a user through a web browser application and displaying outputs to a user. In some cases, the browser extension 103 can exchange data that is used to perform an adaptive purchase evaluation with one or more of the adaptive evaluation service(s) 104 and the home data service 106.

The browser extension 103 can be configured to collect and analyze information about a browsing session occurring on the web browser application. For example, the browser extension 103 can parse and/or scrape a website being displayed by the web browser application. This can include collecting data about a uniform resource locator (URL), text, pictures, videos or other web-based content contained on the website, metadata associated with the website, and so on. In some cases, the browser extension 103 can be configured to make a determination about the content displayed on the website. For example, based on collecting data about the website, the browser extension 103 can characterize that data using pattern matching, word or content recognition, artificial intelligence such as a neural network, or the like. The browser extension can be configured to associate or determine a content classifier for a website, web-based content, or other information displayed by the web browser application. For example, a content classifier can be associated with a listing page that is used to classify websites or web-based content as including listing data such as a property listing. In some cases, the browser extension 103 may pass information collected about a website to the adaptive evaluation service 104 and the classification of a website (e.g., associated with a content classifier) may be performed remotely by the adaptive evaluation service 104. The browser extension 103 can be configured to display one or more user interface elements to a user of the client device 102. In some cases, these interface elements may be displayed within the web browser application.

The browser extension 103 can be configured to convert data obtained from the website, typically in a form adapted for viewing or access using a web browser into a normalized or uniform data schema that is adapted for input into the adaptive analysis to generate a purchase recommendation. In some cases, website data related to a property listing may be stored a first data structure that is configured for displaying information to a user. For example, the first format may be a markup text-based data structure and the browser extension can be configured to processes the markup text-based data to obtain information about the property listing, such as an asking price, address, and/or other relevant information. In some cases, the browser extension may convert the data extracted from the text-based format to a normalized data schema that can be processed by the analysis engine such as the adaptive evaluation service 104. In some cases, the extracted data may be packaged into an object-based format that can be used by the adaptive evaluation service 104 to retrieve additional data about the property and perform the adaptive purchase analysis. Accordingly, in response to navigating to a listing page, the system may automatically identify the current page as a property listing page and generate the adaptive purchase analysis.

The browser extension 103 can be configured to authenticate a user account that is associated with a user of the web browser application. For example, upon browser activation, the browser extension 103 can authenticate the user account with the adaptive evaluation service 104. The browser extension 103 can pass authentication credentials associated with a user account to the adaptive evaluation service 104, which can verify the user credentials and pass an authentication response back to the browser extension 103. In some cases, the browser extension 103 and the adaptive evaluation service 104 can pass information during an active browsing session, which can include information about user interaction(s) with the browser extension 103, information about a current website, information retrieved from other sources such as the home data service 106, and the results of analyses performed at the client device 102 and/or the adaptive evaluation service 104. In some cases, the browser extension 103 can, via the authentication scheme, serve as a privacy firewall to protect a user's sensitive data including financial information or other potential sensitive data.

In some cases, the system can be configured to authenticate a user account by using an email address. For example, the system can send an email to an email address associated with a particular account and the email can include a link to the adaptive evaluation service interface, which includes a token that can be used to authentic access from the link. The link and/or token may be associated with a particular user account, which can be used to retrieve data associated with the user account and generate a personalized recommendation as described herein. In some cases, the system may use a stored cookie or other authenticating element in order to authenticate a user account or session. The cookie may be created as a result of a prior authorization sequence provided by a related system, affiliated system, or trusted system.

The adaptive evaluation service 104 can be implemented as a networked processing platform for performing one or more aspects of an adaptive purchase analysis for a property listing. In some cases, the adaptive evaluation service 104 can include one or more sub-services, such as a recommendation engine 108, and a user account manager 110. The adaptive evaluation service 104 can also be configured to interface with one or more databases 109, one of which is shown for clarity.

The recommendation engine 108 can perform one or more aspects of the adaptive purchase analysis discussed herein. The recommendation engine 108 may receive data from the client device 102, the home data service 106, the user account manager 110, and the database 109 to perform one or more aspects of the adaptive purchase analysis.

The user account manager 110 can associate each user with one or more user accounts, which may include information related to each user. The user account can include information related to permissions of the user, such as login credentials, and information related to the user's current real estate assets, such as current loan information or other information. Information associated with different user accounts may be stored in the database 109 associated with the adaptive evaluation service 104. In some cases, the user account manager 110 can be configured to communicate with the browser extension 103 to allow secure data transmission between the browser extension 103 and the adaptive evaluation service 104. For example, the client device 102 can transfer authentication tokens, such as a Java Script Object Notation web token (JWT), with the adaptive evaluation service 104, or other suitable encryption or authentication schemes.

The client device 102 and/or the adaptive evaluation service 104 can be configured to retrieve data from the home data service 106 and use that data to perform the adaptive purchase evaluation and/or future listing evaluation described herein. The home data service 106 can include publicly accessible or private data, such as lien data, loan data (e.g., amount, rate, term, originator, and so on), selling history of a property, last sold price, home size, number of bedrooms and baths, and the like.

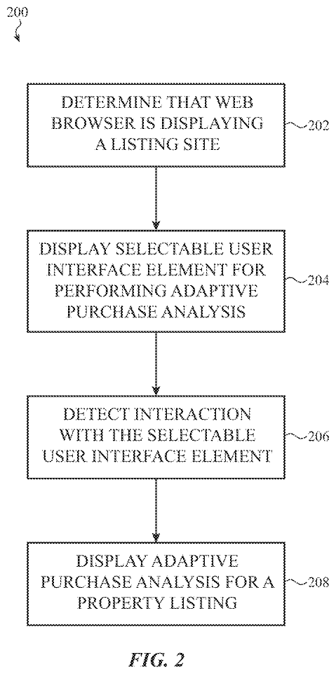

FIG. 2 shows an example process flow 200 for determining that a user is viewing a property listing and generating a real-time adaptive purchase analysis. The process may be performed by a network system such as the network system 100 described herein.

At step 202, the process flow 200 can include determining that the web browser is displaying a listing site. In some cases, this can include collecting and analyzing information about a web-based content associated with a website that is being displayed by the web browser. The process 200 can include a browser extension analyzing a URL, text fields, or other web-based content associated with a current website being displayed in the web browser application. Additionally or alternatively, the browser extension can collect metadata associated with the web page. Using the collected data, the web browser application can be configured to make a determination as to whether the webpage being displayed by the web browser application corresponds to a listing site. In some cases, the determination can include matching the URL to a set of URLs that is associated with a real estate listing site. For example, if the URL of the current webpage matches a URL in the set of real estate URLs, then the browser extension can be configured to classify the current website as a listing site. In some cases, classifying a website or other web-based content as a listing site can include assigning a content classifier to the website or webpage. For example, upon determining that a particular website is a listing site, the browser extension can assign a content classifier to the website that identifies it as a listing page.

In other cases, the determination can be made using word or phrase recognition to identify keywords contained on a website along with a frequency of different words used. The identified words or phrases can be compared to a set of defined words that is associated with a real estate listing site and/or rental listing site. A confidence level can be associated with the determination that a currently displayed website is a real estate website. For example, a confidence level may be based on the number of times specific words are used on a particular website. In some cases, the determined confidence level can be compared to a threshold and, if the confidence level satisfies the threshold, then the browser extension can determine that the current website is a listing site and assign it a content classifier corresponding to a listing page.

At step 204, in accordance with a determination that the content classifier corresponds to a listing page, the process 200 can include displaying a selectable user interface element in the web browser application. The selectable user interface element can provide a visual indicator that an adaptive purchase analysis is available for one or more property listings displayed on the listing site. In some cases, the adaptive purchase analysis may automatically be performed for one or more property listings displayed on the listing site and the selectable user interface element can be displayed to indicate that the adaptive purchase analysis has been performed and is ready to be viewed. In other cases, the selectable user interface element can be used to initiate an adaptive purchase analysis for one or more property listings displayed on the listing site. For example, the adaptive purchase analysis can be performed in response to a user selecting or otherwise interacting with the selectable user interface element.

In some cases, the selectable user interface element is displayed over at least a portion of a property listing that is contained on the listing site. For example, the selectable user interface element may be located over a specific property listing in which an adaptive purchase analysis has been performed or is available to be performed.

At step 206, the process 200 can include detecting a user interaction with the selectable user interface element. This can include detecting a user-click in the selectable user interface element or other input action at the location of the selectable user interface element.

At step 208, in response to detecting the user interaction with the selectable user interface element, the process 200 can include displaying the adaptive purchase analysis for the associated property listing. In some cases, displaying the adaptive purchase analysis can include opening a new window within the current web browser interface. The new window can display information related to the adaptive purchase analysis, which is described in further detail herein. In some cases, the window can be positioned as part of the real estate listing site, which can include positioning the new window at least partially over or adjacent to the associated property listing. In some cases, the browser extension can create a popup window or other type of window or user interface element that is associated with a particular property listing. For example, the browser extension can cause a popup window to overlap at least a portion of a property listing displayed by the browser.

In some cases, the selectable user interface element may continue to be displayed by the browser extension and, if an additional interaction with the selectable user interface element is detected, the browser extension can be configured to perform additional actions, such as collapsing the new window that is displaying the adaptive purchase analysis and/or providing a list of additional options that may include an option to save information associated with a listed property being displayed on a property summary page along with the adaptive purchase analysis to the user's account, or the like.

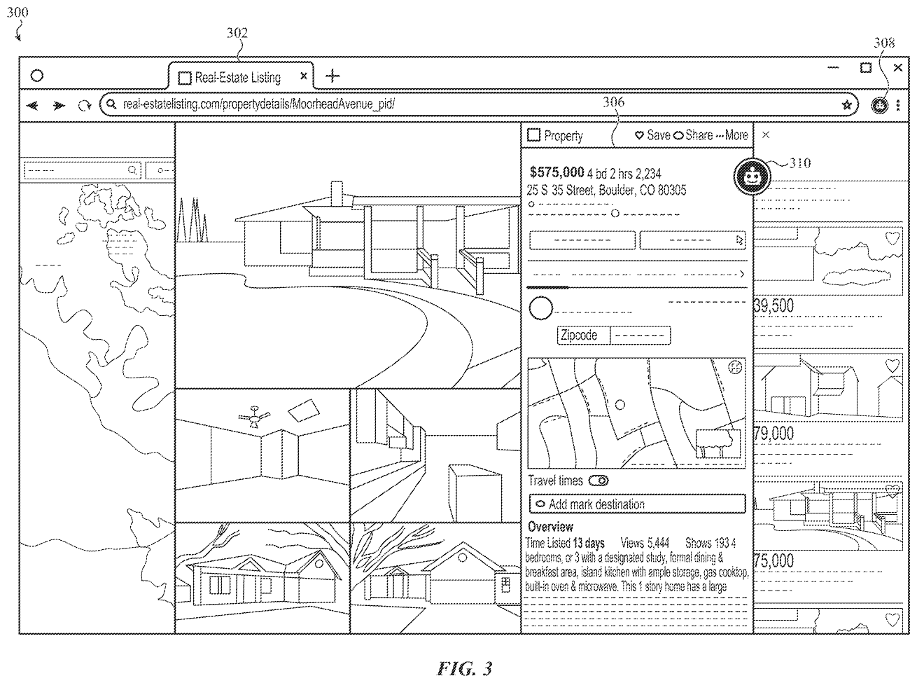

FIG. 3 shows an example web browser interface 300 for providing a real-time or dynamically adaptive purchase analysis. The web browser interface 300 can include one or more regions or panes that are used to display different information to a user and can include various user interface elements that can be selected by a user to perform different functions. For example, the web browser interface 300 can include a browser window 302 that includes a property listing. The browser window 302 can include pictures 304 of the property listing, a property summary pane 306, a browser extension element 308, and a selectable user interface element 310. In some cases, content from a listing site is provided through the web browser's application using data obtained from the URL.

The browser extension element 308 can be a visual element that indicates that the web browser extension for performing the adaptive purchase analysis is active. In some cases, the browser extension element 308 can be configured to provide one or more options for a user to perform different functions associated with their user account. For example, clicking on or otherwise interacting with the browser extension element can bring up a pane or window that displays information related to the user account, such as whether the user is logged in, an identification of the user account, and so on.

In some cases, a received click or other interaction with the browser extension element 308 may be used to initiate one or more adaptive purchase analyses for properties displayed in the browser window 302. For example, in response to detecting a user interaction at the browser extension element 308, the browser extension can be configured to identify property listings displayed in the browser window and perform an adaptive purchase analysis for the one or more property listings.

The web browser interface 300 and/or the browser window 302 can include information related to the property listing such as a URL and or other metadata that is associated with the property listing, or other web-based content. The browser extension can parse, retrieve, or otherwise access this data and associate this data with an adaptive purchase analysis that is performed for the property listing. The browser extension can be configured to save retrieved data associated with a listed property being displayed on a property summary page to a user account. In some cases, information that is not able to parsed from content received from the URL may cause a prompt to be displayed to a user, which may allow the user to enter the missing content.

The property summary pane 306 can include information related to the property listing such as a price, address, number of bedrooms and bathrooms, amenities, information related to the area where the property is located, and so on. In cases where the property listing is for a rental property, the summary pane 306 can include related rental information such as a recurring rental rate, rental term, or other information. The browser extension can parse, scrape, or otherwise retrieve various portions of this data for use in the adaptive purchase analysis associated with the property listing.

The browser extension 308 can be configured to cause the selectable user interface element 310 to be displayed in the web browser window 302. As described herein, the selectable user interface element 310 can indicate that an adaptive purchase analysis has been performed for the displayed property listing. In some cases, the selectable user interface element 310 can be used to indicate that an adaptive purchase analysis can be performed for the property listing and in response to the web browser extension determining a user interaction with the selectable user interface element 310, the browser extension 308 can cause the adaptive purchase analysis to be performed.

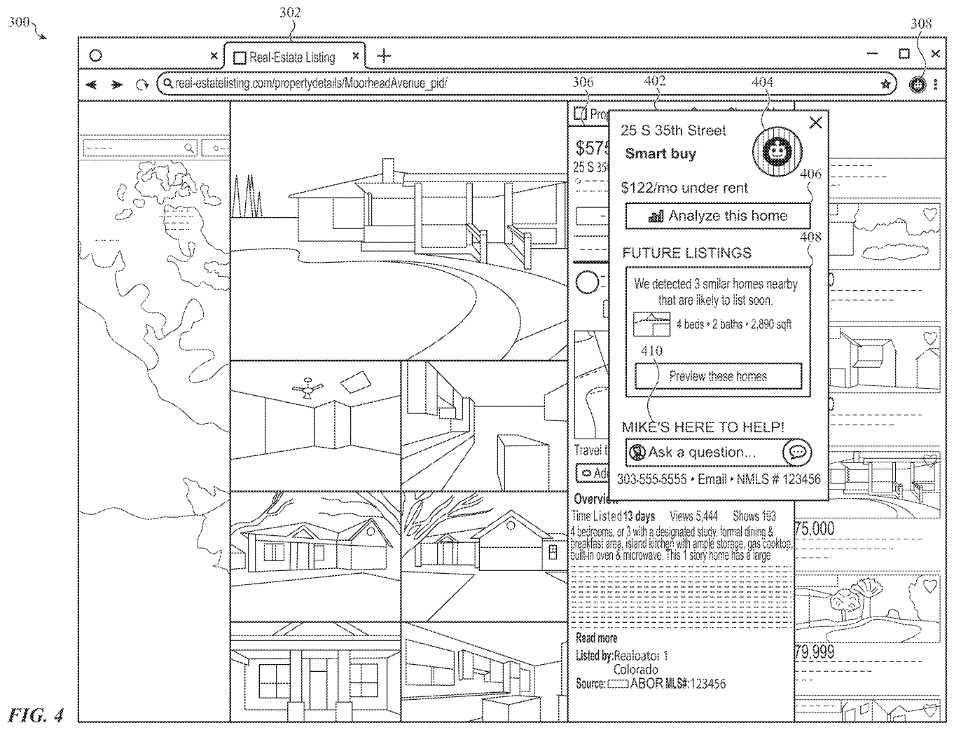

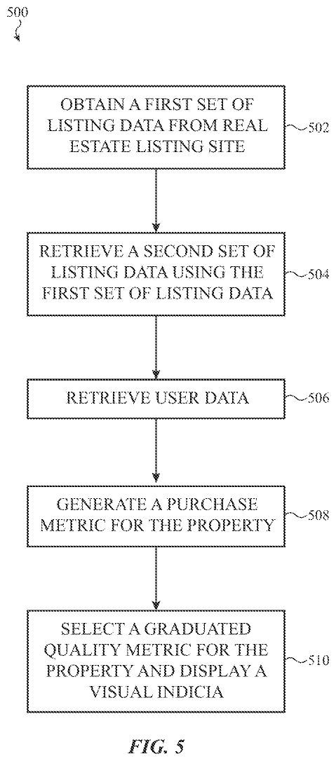

FIG. 4 shows an example web browser interface 300 that includes displaying a window 402 that displays information related to an adaptive purchase analysis. The window 402 can be opened by the browser extension in response to detecting an interaction with the selectable user interface element 310. The window 402 can include a purchase recommendation as a visual indicia 404 for the property and based on a specific user account. For example, the visual indicia can have a visual characteristic that indicates a level of positivity for this purported transaction for the active user account. The visual indicia can change in response to the selected graduation metric that is described herein. Accordingly, the purchase recommendation can be specific to a user account and different user accounts can result in different purchase recommendations for the same property listing. The purchase recommendation can include computing or selecting a graduated evaluation metric that is for the property listing and specific to a user account, which is described in greater detail herein such as in relation to FIG. 5. The window 402 includes graphical elements that correspond to the graduated evaluation metric but may not be the metric itself. For example, if the graduated evaluation metric is associated with a positive indication for the purported property listing, the visual indicia 404 can include a positive visual element such as a smiling face, phrase, a particular color, number, letter, and so on.

The window 402 can also include a selectable option 406 for performing the adaptive purchase analysis on the property in cases in which the adaptive purchase analysis has not already been performed. For example, the browser extension can be configured to wait to perform the adaptive purchase analysis until detecting an interaction with the selectable option 406. In some cases, the window can include an option to view additional information about the purchase recommendation and/or why the purported transaction for the property listing is rated a particular way.

In some cases, the browser extension can include one or more controls or other options for changing inputs that are used to arrive at a particular purchase recommendation. For example, the user may be able to click on the browser extension element 308 and adjust one or more values of their personal information to see if it changes the evaluation. This can include changing their salary estimate or reducing their debt load, modifying a target budget, changing buying goals, or other factors to see how it affects the evaluation.

In some embodiments, the window 402 can include a future listing summary 408 that can display properties which are not listed yet, which may be referred to herein as a future listing. The window 402 can also include realtor, loan officer, or other realty or financial professional information 410 that is associated with a user account. For example, the browser extension can be configured to associate a user account with a realtor that can be initiated by a user and/or realtor. The realtor information 410 can include an option for contacting the realtor, loan officer, financial planners, insurance agents, or other property buying or renting professionals. In some cases, contacting the realtor using the window 402 can result in the browser extension sending information about the associated property listing to the realtor.

In some cases, the adaptive purchase analyses described herein can be performed for one or more future listings and presented to the user via the web browser application, web browser extension, or other application. Upon identifying a potential future listing, the evaluation server can retrieve additional data for performing the adaptive purchase analysis for the future listing. The analysis server can also access other external data sources to retrieve information related to the selling history of the property associated with the future listing, a current estimated value, recent sale data, and so on. Using the retrieved data, the analysis server can perform the adaptive purchase analysis based on retrieved data that is specific to the user account. For example, the adaptive purchase analysis can include estimating a monthly mortgage for the property associated with the future listing and determining a current monthly real estate cost for the user. The adaptive analysis can be used to select potential futures listing that can be displayed in the features listing summary 408 and/or accessed by the user through the future listings summary. In some cases, the analysis service can be configured to select and display future listings that satisfy a defined graduation metric and/or result in a specific purchase recommendation. For example, unlisted properties that are analyzed and result in a positive purchase recommendation could be displayed to the user when the feature listing summary 408 is selected.

FIG. 5 shows an example process flow 500 for generating real-time adaptive purchase analyses for a property listing. The process may be performed by a network system such as the network system 100 described herein. In some cases, the process 500 can be performed in response to determining that the web browser application is displaying a real estate listing site as described herein.

At step 502, the process 500 can include obtaining a first set of listing data by analyzing the text fields contained in the listing website. In some cases, the browser extension can be configured to analyze web-based content associated with a website to identify information associated with a specific property listing displayed on the listing site. The first set of information that is obtained by parsing and/or scraping the listing site can include a URL associated with the listing, a listing price, address of the property, a listing image URL, or the like. In some cases, information for the first set of listing data can be obtained through accessing metadata from the listing site and that is associated with the property listing. Analyzing the web-based content can include analyzing text fields, a URL, or other content contained within the website.

In some cases, the browser extension can be configured to send the information to a remote analysis server and one or more steps of the process 500 can be performed at the remote analysis server or a combination of the remote analysis server and the browser extension. In other cases, the browser extension may receive additional data from the one or more remote sources, such as the remote analysis server, and one or more steps of the process 500 can be performed at the browser extension.

At step 504, the process 500 can include using the first set of listing data to retrieve a second set of data associated with the property listing from one or more databases. In some cases, the address for the property listing that was identified from the property summary page can be used to request loan data for the property, which can include a loan amount, loan origination data, loan term, loan rate, loan position, lien data, and/or the like. Additionally or alternatively, the property address can be used to retrieve additional information from one or more independent databases, such as the last selling price for the property, selling history, appraisal data, insurance information, current estimated value, and/or the like. In further examples, the address can be used to retrieve additional information for the property listing such as a demand for properties in the same zip code, recent sale data for other properties in the same zip code, among others. In other examples, renting data for the property listing can be retrieved from one or more databases, which can include information related to rental rates for the property.

The second set of listing data can be used to determine an estimated recurring cost if the user were to purchase the property associated with the property listing. For example, the second set of listing data can be used to determine an estimated monthly cost of owning the property, which can be based on estimated costs that include loan amount, mortgage insurance, property taxes, home insurance, homeowner association fees, maintenance costs, and so on. In some cases, determining an estimated recurring cost for the property can include performing an appreciation analysis on the property, such as a five-year appreciation analysis.

At step 506, the process 500 can include retrieving user data and determining a current recurring property cost for the user associated with the user account. In some cases, this information may be collected from a user upon setting up a user account and stored in one or more databases such as database 109, described herein. The user data can be retrieved by the adaptive analysis server and/or the browser extension. The user data can include their current home address, loan information, current equity, amortization data, taxes, maintenance cost, salary data, debt information, and/or the like. In some embodiments, the user data can be used to retrieve additional data about the user's current property cost from one or more databases. For example, the user's home address can be used to retrieve loan data for their current residence, tax data, amortization schedule, and the like. If the user is currently renting, the user data can include their current rent cost, lease term, and/or other rental expenses. In some cases, the user data can be accessed by connecting the user account to a rental or insurance portal. The collected user data can be associated with the user account. The adaptive analysis server and/or browser extension can also use the user data to determine the user's current recurring cost of living such as a current monthly cost of living.

In some cases, the browser extension and/or other web interface can prompt the user to input additional information that can be used to further customize the adaptive purchase analysis. Examples of these types of information can include a property budget, current down payment savings, buying timeline, and so on. For example, a user may be able to enter a current monthly budget for property costs (e.g., mortgage cost, estimated maintenance, taxes, home insurance, and so on), which may be used to generate a graduated evaluation metric.

In some cases, the browser extension may prompt a user to verify that details about the listing are correct and/or prompt a user to enter details about the listing that can be used to perform the adaptive purchase analysis. For example, the system may not be able to retrieve one or more variables, such as a purchase price, listing address and so on from a primary data source. In this cases, the system may not be confident that one or more metrics are accurate and/or a confidence value associated with the metric and/or the data source may cause the web browser extension to prompt the user to confirm or enter information for these variables. For example, the web browser extension may prompt the user to confirm the asking price and/or address of a property listing prior to performing the adaptive purchase analysis. In other cases, the web browser extension may prompt the user to enter information, such as an asking price, listing address, and/or any other suitable information and use this entered information for preforming the adaptive purchase analysis.

In some cases, the browser extension may allow a user to adjust one or more variables associated with the real-time adaptive purchase analysis. For example, the browser may include modifiable visual inputs that a user can modify to adjust parameters of the adaptive purchase analysis and the system can update the purchase analysis based on changes to these parameters. In some cases, the system may allow a user to modify a property budget, a down payment, interest rate, how long they may stay in the home, a rental income and so on. Changes to these inputs can cause the system to update the adaptive purchase analysis.

At step 508, the process 500 can include generating a purchase metric for the property listing based on using the first set of listing data, the second set of listing data, and the first set of user information. The purchase metric can be based on the estimated recurring cost associated with the property and the current recurring property cost associated with the user account. In this regard, the purchase metric/score may be based on data associated with a specific user account. For example, different purchase metrics can be generated for different users for the same property. Accordingly, the adaptive purchase analysis performed by process 500 can be specific to each user account in relation to a specific property associated with the property listing.

At step 510, the process 500 can include using the purchase metric to select a graduated evaluation metric that is used to provide a purchase recommendation to the user. For example, a set of graduated evaluation metrics can be defined and each graduated evaluation metric can be associated with a different purchase recommendation. A first graduated evaluation metric can be associated with a positive purchase recommendation that indicates that the property would be less expensive than the user's current property costs. The positive purchase recommendation can be based on the purchase metric/score indicating that the estimated recurring costs associated with the property are less than the user's current recurring property costs. A second graduated evaluation metric can be associated with a neutral purchase recommendation that indicates that the property would be substantially similar to the user's current property costs. The neutral purchase recommendation can be based on the purchase metric/score indicating that estimated recurring costs associated with the property are substantially the same as the user's current recurring property costs. A third graduated evaluation metric can be associated with a negative purchase recommendation that indicates that the property would be more expensive than the user's current property costs. The negative purchase recommendation can be based on the purchase metric indicating that estimated recurring costs associated with the property are more than the user's current recurring property costs.

In some embodiments, at step 510, the analysis server or the browser extension can compare the purchase metric to a threshold range associated with each of the various graduated evaluation metrics. The graduated evaluation recommendation having a threshold range that satisfies the evaluation metric can be selected and associated with the user account in relation to the property associated with the property listing. Accordingly, for a specific user account, a graduated evaluation metric can be associated with each analyzed property.

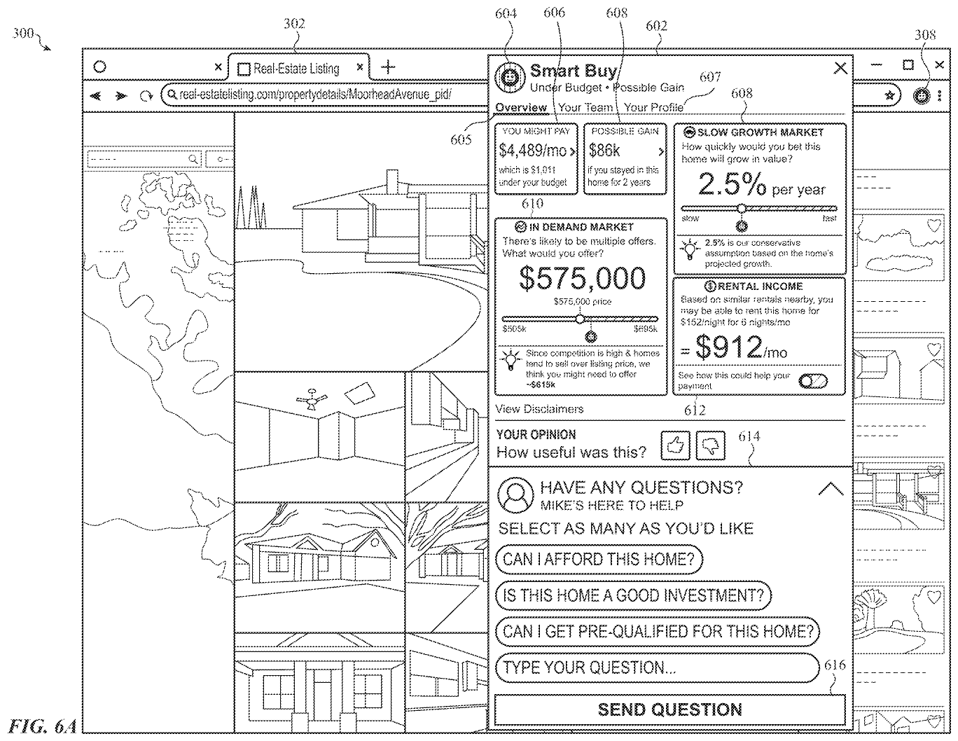

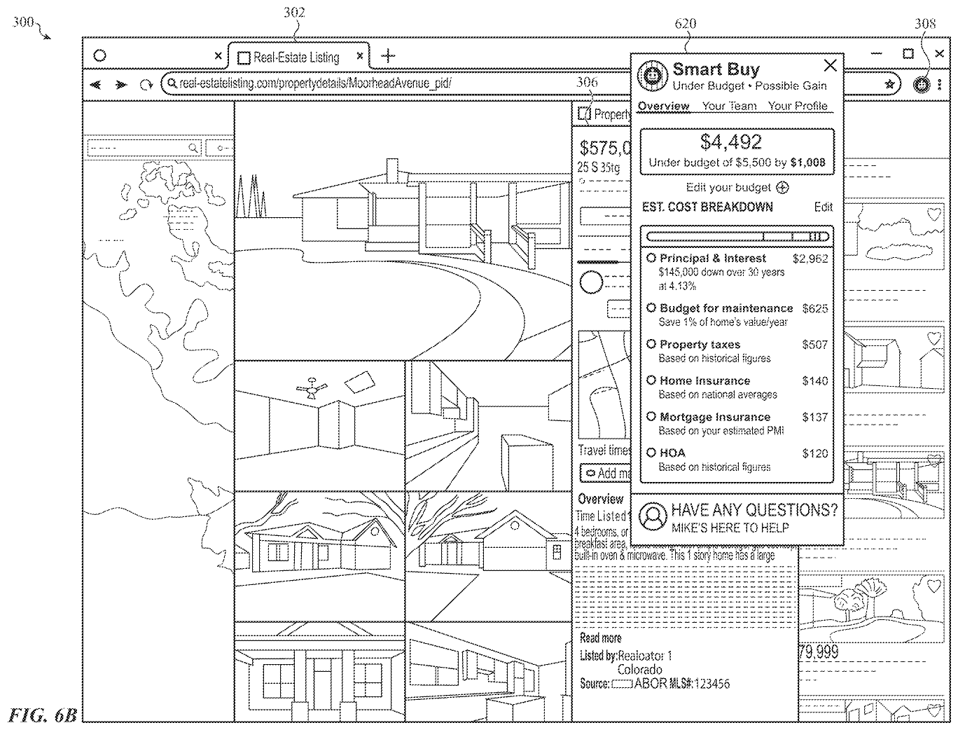

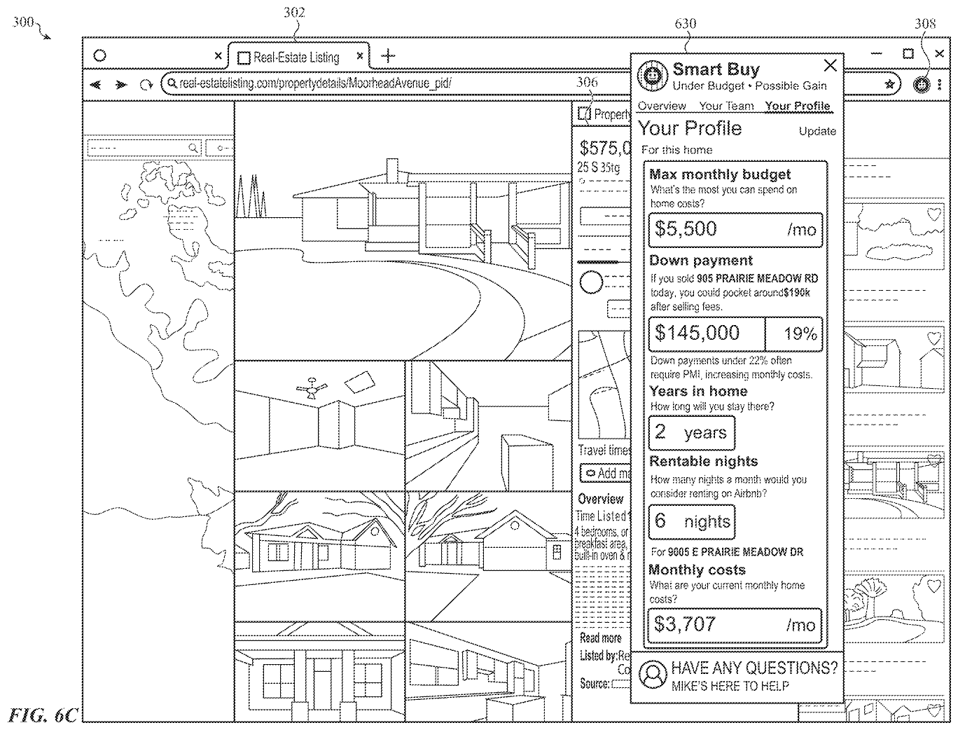

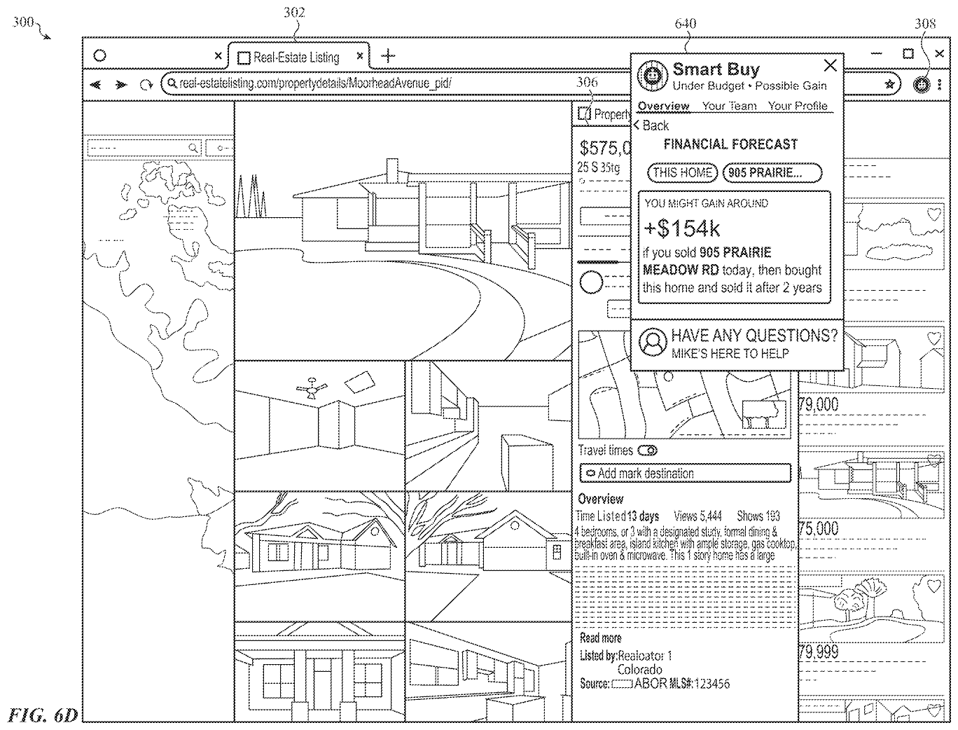

FIGS. 6A-6D show example graphical user interface elements of the web browser interface 300 displaying information related to an adaptive purchase analysis. In these examples, the graphical user interface elements are windows or frames that overlay the content associated with the listing URL. The information displayed within the windows can be generated as part of the adaptive purchase analysis. In the examples shown in FIGS. 6A-6D the windows can include one or more dynamic user interface elements that accept user input and, in response, cause the adaptive purchase analysis to be updated. As shown in the following examples, the user input may be a sliding or gesture-based input, which may be used to provide a continuously or step-wise adjustable user input, which may be used to automatically and dynamically display the results of the updated adaptive purchase analysis. Accordingly, as one or more of the parameters controlled by the user input are modified, the system may update the adaptive purchase analysis and information displayed in the windows.

Information entered via the graphical user interface may be intentionally not stored by the system in order to protect potentially sensitive financial information entered by the user. Note that some information may be stored temporarily, locally, through the normal operation of the browser, but not stored by the system or the operator of the underlying URL. This functionality allows the user to engage with active data obtained from the URL, provide potentially sensitive financial or personal information, and utilize the adaptive purchase analysis provided by the plugin without risking disclosure of personal or financial data.

FIG. 6A shows an example of a window 602 that can be displayed within the web browser interface 300. The window 602 may be displayed in response to a user selecting the browser extension 308 or the selectable user interface element 310, as described herein. The window 602 may include a visual indicia 604 for the purchase recommendation of the property, which may be the same or correspond to the visual indicia generated as part of the adaptive purchase analysis, as described herein.

The window 602 may include one or more options for displaying information that is input into the adaptive purchase analysis and/or information that is generated from the adaptive purchase analysis. In some cases, the window 602 can include a dynamically configurable budget input 606 for setting a monthly property budget. The budget input 606 may include a maximum amount for spending on property related costs, such as a mortgage payment, property taxes, home insurance, maintenance, insurance associated with the property and so on. In some cases, a user may be able to select the budget option 606 to view additional details associated with the budget. For example, selecting the budget input option 606 may cause a budget interface 620 to launch as shown in FIG. 6B.

As shown in FIG. 6B, the budget interface 620 may include additional details about the budget and/or information about the user's budget in relation to the currently viewed property listing. For example, the budget interface 620 may display an estimated cost (e.g., monthly cost) associated with the property listing and based on the inputs to the adaptive purchase analysis. This estimated cost for the property listing can be compared to the user's current budget and the budget interface 620 can indicate whether the property listing is above or below a user's target budget. In some cases, the budget option can factor into the adaptive purchase analysis and purchase recommendation. For example, if a monthly budget for the property listing is below a user's target budget, the adaptive purchase analysis use this as a criteria in order to increase a positivity of the purchase recommendation. If a monthly budget for the property listing is below the user's target budget, the adaptive purchase analysis may decrease a positivity of the purchase recommendation for that user.

The budget interface 620 can also include a visual breakdown of the elements used to compute the budget so that a user can see how different factors of the property listing affect the budget. For example, the cost breakdown can be displayed as a bar or linear scale element and include elements for each major factoring including, by way of example, information related to the mortgage payment (e.g., principal and interest amount), budget for maintenance, tax information (e.g., property tax), insurance information (e.g., home insurance, mortgage insurance, etc.), or any other suitable costs associated with the property.

As shown in FIG. 6A, the window 602 can include a projected gain summary 608, which may display information related to how much a user may gain by purchasing the property associated with the listing and owning the property for a given duration. In some cases, the projected gain summary 608 can be factored into the adaptive purchase analysis. For example, higher gains and/or higher gains per a duration can increase a net positivity of the purchase recommendation. Accordingly in some cases, a highly positive factor, such as a highly positive projected gain may result in a positive purchase recommendation even when one or more other factors create a decrease in purchase recommendation. For example, if the possible gain is sufficiently large, the adaptive purchase analysis may generate a positive recommendation (e.g., Smart Buy), even if the associated property costs are greater than a set monthly budget.

In some cases, the window 602 can include an adjustable appreciation value 608, which may continuously adjustable user input used to provide a projected appreciation of the associated property. In some cases, the system may be configured to set a default appreciation value 608, which may be adjusted by the user via the sliding input control or other input element. The default appreciation value 608 may be based on appreciation data collected by the system, for example, from a third-party source. In some cases, the system, as part of the adaptive purchase analysis, may modify retrieved appreciation values, for example, to make the estimate more conservative. As shown in FIG. 6A, the system may allow the user to modify a default or estimated appreciation value 608 using the sliding input control that allows the user to modify the appreciation value 608 in a continuous or step-wise fashion. In response to the user modifying the appreciation value, the system may automatically and dynamically update the adaptive purchase analysis and update one or more graphical outputs in the window 602 based on the updated purchase analysis.

As shown in FIG. 6A, the window 602 may include a down payment option 610, which may display information related to a down payment for the property associated with the property listing. In some cases, the system may be configured to set a default down payment value for the down payment option 610, which may be adjusted by the user using a sliding input control or other input element. The default down payment may be based on an asking price determined from the property listing. The default down payment value may take into account factors such as competition associated with the property, which can be based on data collected from similar listings, other home buying transactions in the same area, or other suitable factors.

As shown in FIG. 6A, system can allow the user to modify a default or estimated down payment value using the controls or input elements provided within the window 602. For example, the system may provide the sliding input control that allows the user to provide a continuous or step-wise user input in order to modify the down payment value displayed in the down payment option 610. In response to the user modifying the down payment value, the system may automatically and dynamically update the adaptive purchase analysis and update the window 602 based on the updated purchase analysis.

In some cases, the window 602 can include a rental income option 612, which may display information related to potential income from renting the associated property. For example, a user may be able to set an amount of time they expect to rent the property (e.g., number of nights per month). In response to user input regarding a rental parameter, the system may update the adaptive purchase analysis and automatically and dynamically update the window 602 based on the updated purchase analysis. Example user interface elements that may be used to receive user input for computing the adaptive purchase analysis is displayed in window 630 of FIG. 6C.

In some cases, a user may be able to modify other aspects of the adaptive purchase analysis, for example the budget input 606, one or more aspects of the projected gain summary 608, the down payment option 610, rental income 612, and/or any other suitable parameters. In some cases, the system may provide options for modifying one or more of these parameters in the window 602. In other cases, the system may launch a different window, which may provide fields for modifying one or more of these parameters. For example, in response to a user selecting the profile tab 607, the system may launch a profile window 630 as shown in FIG. 6C.

The profile window 630 may include one or more input fields that can be populated and/or modified by a user to set various parameters associated with the adaptive purchase analysis. For example, the window 630 may include an input field for inputting and/or modifying a budget parameter (e.g., max monthly budget), a down payment parameter (e.g., amount and/or percent), how long the user projects they will own the associated property, a rental parameter, or any other suitable properties.

Additionally or alternatively, the profile window 630 may include one or more options for inputting information relevant to a property owned by the user. For example, this can include a user's monthly costs associated with their current property. Using this information, the adaptive purchase analysis may be able to generate comparative information between the user's current property and the property displayed in the property listing. For example, as shown in FIG. 6D, the system may generate a compare window 640 that provides comparative information between a user's current property and the property associated with the displayed property listing. The adaptive purchase analysis can use one or more of the user inputted parameters and/or retrieved parameters about the user's current property and the property associated with the listing to generate a projected gain/loss associated with selling the current property and buying the property in the listing.

In some cases, the window 602 can include a contact option 614 for contacting a loan officer, real-estate agent, broker or other user of the system. The contact option 614, may include a set of pre-configured questions that a user may select and/or an option for inputting a question for the loan officer or other user. In some cases, in response to selecting (or inputting) a question, the system may send the question to the loan officer along with the user's profile and/or contact information. Additionally or alternatively, the system may capture the current parameters that are set in the window 602 and/or being used to perform the adaptive purchase analysis and generate the purchase recommendation and send those to the loan office (or other user) along with the question.

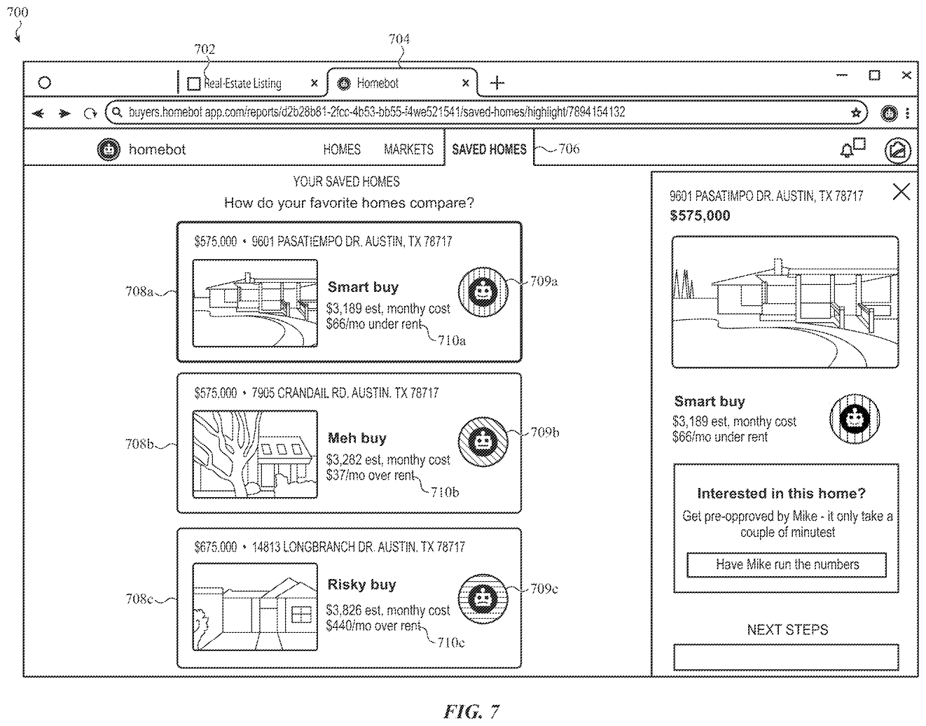

FIG. 7 shows an example web browser interface 700 for displaying multiple adaptive purchase analyses for various properties associated with different property listings. The web browser interface 700 can be an example of the web browser interfaces described herein such as web browser interface 300 and 400. The web browser interface 700 can include a first browser window 702, which can be an example of a listing website browser window, such as browser window 302. The web browser interface 700 can also include a second browser window 704, which can include a browser interface for displaying information related to one or more adaptive purchase analyses associated with a specific user account.

The second browser window 704 can include a display pane 706 for displaying one or more adaptive purchase analyses 708 for various properties. In some cases, the adaptive purchase analyses 708 may be saved to a user account, for example, using a saving option provided in the browser extension. The adaptive purchase analyses 708 can include a summary of the associated property listing along with displaying a visual indicia 709 of the graduated evaluation metric for each purported property transaction. In some cases, the adaptive purchase analyses 708 can also include purchase data 710 for the associated property listing.

A first adaptive purchase analysis 708a performed for a first property listing as described herein provides an example of a positive purchase recommendation. The first adaptive purchase recommendation includes a first visual indicia 709a associated with a first graduated evaluation metric and first purchase data 710a. In this example, the first graduated evaluation metric corresponds to a positive purchase recommendation. Accordingly, the first visual indicia 709a can be a graphic that portrays a positive purchase recommendation (e.g., “Smart Buy” and/or smiling face with a first color background) to indicate that the property listing would be less expensive than the user's current property cost. The first purchase data 710a can display the estimated monthly cost of owning the associated property (e.g., “$3,189 est, monthly cost”) as well as a comparison between this cost and a current property cost of the user (e.g., “$66/mo under rent”).

A second adaptive purchase analysis 708b performed for a second property listing as described herein provides an example of a neutral purchase recommendation. The second adaptive purchase recommendation includes a second visual indicia 709b associated with a second graduated evaluation metric and second purchase data 710b. In this example, the second graduated evaluation metric corresponds to a neutral purchase recommendation (e.g., “Meh Buy” and/or neutral face with a second color background) that indicate that the property listing would be substantially similar to the user's current property cost. The second purchase data 710b can display the estimated monthly cost of owning the associated property (e.g., “$3,282 est, monthly cost”) as well as a comparison between this cost and a current property cost of the user (e.g., “$37/mo over rent”).

A third adaptive purchase analysis 708c performed for a third property listing as described herein provides an example of a negative purchase recommendation. The third adaptive purchase recommendation includes a third visual indicia 709c associated with a third graduated evaluation metric and third purchase data 710c. In this example, the third graduated evaluation metric corresponds to a negative purchase recommendation (e.g., “Risky Buy” and/or frown face and third color background) that indicates that the property listing would be more expensive than the user's current property cost. The third purchase data 710c can display the estimated monthly cost of owning the associated property (e.g., “$3,826 est, monthly cost”) as well as a comparison between this cost and a current property cost of the user (e.g., “$440/mo over rent”).

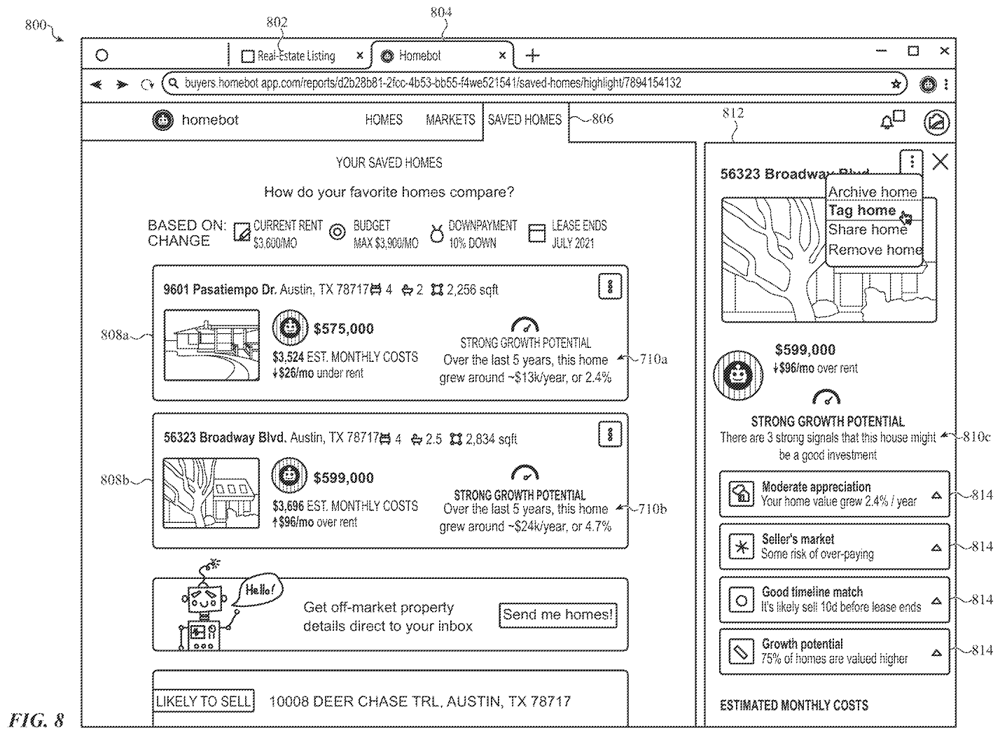

FIG. 8 shows an example browser interface 800 for displaying multiple saved adaptive purchase analyses for a property listing. The browser interface 800 can be an example of the web browser interfaces described herein such as web browser interface 300, 400 and 700. The browser interface 800 can include a first browser window 802, which can be an example of a real estate listing website browser window, such as browser window 302. The web browser interface 800 can also include a second browser window 804, which can be an example of a browser interface for displaying information related to one or more adaptive purchase analyses associated with a specific user account such as second browser window 804.

Display pane 806 can include one or more adaptive purchase analyses 808 for various property listings, which can be examples of the purchase analyses described herein such as adaptive purchase analyses 608. In the example shown in FIG. 8, the adaptive purchase analyses 808 can include a growth potential metric 810, which can be factored into the purchase recommendation. For example, a second purchase recommendation 808b provides an example of a property listing that without the growth potential metric 810 would be classified as a neutral or risky purchase due to the higher monthly cost as compared to the user's current property cost. However, the second growth potential metric 810b indicates that the associated property listing has a higher growth potential. In some cases, the growth potential metric 810 can be factored into the purchase metric.

Display pane 806 can also include a detailed view pane 812, which can be displayed in response to a user selecting one of the adaptive purchase analyses 808. The detailed view pane 812 can include additional information 814 related to the adaptive purchase analyses 808. For example, the additional information 814 can include appreciation data, market trends, timing data, comparison to other properties in a similar area, and/or other data related to the property listing.

FIG. 9 shows a sample electrical block diagram of an electronic device 900 that may perform the operations described herein. The electronic device 900 may in some cases take the form of any of the electronic devices described with reference to FIGS. 1-8, including client devices 102, and/or servers or other computing devices associated with the adaptive evaluation service 104 and the home data service 106. The electronic device 900 can include one or more of a processing unit 902, memory 904 or memory storage device, input devices 906, a display 908, output device(s) 910, and a power source 912. In some cases, various implementations of the electronic device 900 may lack some of these components and/or include additional or alternative components.

The processing unit 902 can control some or all of the operations of the electronic device 900. The processing unit 902 can communicate, either directly or indirectly, with some or all of the components of the electronic device 900. For example, a system bus or other communication mechanism 914 can provide communication between the processing unit 902, the power source 912, the memory 904, the input device(s) 906, and the output device(s) 910.

The processing unit 902 can be implemented as any electronic device capable of processing, receiving, or transmitting data or instructions. For example, the processing unit 902 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 900 can be controlled by multiple processing units. For example, select components of the electronic device 900 (e.g., an input device 906) may be controlled by a first processing unit and other components of the electronic device 900 (e.g., the display 908) may be controlled by a second processing unit, where the first and second processing units may or may not be in communication with each other.

The power source 912 can be implemented with any device capable of providing energy to the electronic device 900. For example, the power source 912 may be one or more batteries or rechargeable batteries. Additionally or alternatively, the power source 912 can be a power connector or power cord that connects the electronic device 900 to another power source, such as a wall outlet.

The memory 904 can store electronic data that can be used by the electronic device 900. For example, the memory 904 can store electronic data or content, such as audio and video files, documents and applications, device settings and user preferences, timing signals, control signals, and data structures or databases. The memory 904 can be configured as any type of memory. By way of example only, the memory 904 can be implemented as random access memory, read-only memory, Flash memory, removable memory, other types of storage elements, or combinations of such devices.

In various embodiments, the display 908 provides a graphical output, for example, associated with an operating system, user interface, and/or applications of the electronic device 900 (e.g., a chat user interface, an issue-tracking user interface, an issue-discovery user interface, etc.). In one embodiment, the display 908 includes one or more sensors and is configured as a touch-sensitive (e.g., single-touch, multi-touch) and/or force-sensitive display to receive inputs from a user. For example, the display 908 may be integrated with a touch sensor (e.g., a capacitive touch sensor) and/or a force sensor to provide a touch- and/or force-sensitive display. The display 908 is operably coupled to the processing unit 902 of the electronic device 900.

The display 908 can be implemented with any suitable technology including, but not limited to, liquid crystal display (LCD) technology, light-emitting diode (LED) technology, organic light-emitting display (OLED) technology, organic electroluminescence (OEL) technology, or another type of display technology. In some cases, the display 908 is positioned beneath and viewable through a cover that forms at least a portion of an enclosure of the electronic device 900.

In various embodiments, the input devices 906 may include any suitable components for detecting inputs. Examples of input devices 906 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 906 may be configured to detect one or more particular types of input and provide a signal (e.g., an input signal) corresponding to the detected input. The signal may be provided, for example, to the processing unit 902.

As discussed above, in some cases, the input device(s) 906 includes a touch sensor (e.g., a capacitive touch sensor) integrated with the display 908 to provide a touch-sensitive display. Similarly, in some cases, the input device(s) 906 includes a force sensor (e.g., a capacitive force sensor) integrated with the display 908 to provide a force-sensitive display.

The output devices 910 may include any suitable components for providing outputs. Examples of output devices 910 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device 910 may be configured to receive one or more signals (e.g., an output signal provided by the processing unit 902) and provide an output corresponding to the signal.

In some cases, input devices 906 and output devices 910 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 902 may be operably coupled to the input devices 906 and the output devices 910. The processing unit 902 may be adapted to exchange signals with the input devices 906 and the output devices 910. For example, the processing unit 902 may receive an input signal from an input device 906 that corresponds to an input detected by the input device 906. The processing unit 902 may interpret the received input signal to determine whether to provide and/or change one or more outputs in response to the input signal. The processing unit 902 may then send an output signal to one or more of the output devices 910, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and processes described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed and aggregated only for legitimate, agreed-upon, and reasonable uses.

Example computing resources or appliances that may be configured to perform the methods described herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database. Whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

What is claimed is:

1. A computer implemented method for generating a real-time personalized graduated evaluation metric associated with listings being displayed in a web browser application, the computer implemented method comprising operating a browser extension in the web browser application to perform steps of:
authenticating a user account using a set of login credentials and, in response to a successful authentication, obtaining a first set of user information associated with the user account;
analyzing a uniform resource locator and a first set of text fields of web-based content displayed in the web browser application to determine a content classifier;
in accordance with a determination that the content classifier corresponds to a listing page:
obtaining a first set of listing data by parsing a second set of text fields of the web-based content, the first set of listing data comprising a listing price and a listing address;
using the first set of listing data, retrieving from one or more databases a second set of listing data, the second set of listing data including loan information associated with a real estate item referenced on a listing;
generating a purchase metric for the listing based on the first set of listing data, the second set of listing data, and the first set of user information; and
selecting a graduated evaluation metric from a set of graduated evaluation metrics, each evaluation metric in the set of graduated evaluation metrics associated with a respective threshold range, selecting the graduated evaluation metric based on the purchase metric satisfying the respective threshold range of the graduated evaluation metric; and
causing the web browser application to display a popup window containing a graduated visual indicia corresponding to the graduated evaluation metric.

2. The computer implemented method of claim 1, further comprising:
computing a recurring cost for the listing based on the first set of listing data;
computing a recurring cost for a user associated with the user account based on the second set of listing data, the first set of user information, or a combination thereof; and
generating the purchase metric using the recurring cost for the listing and the recurring cost for the user.

3. The computer implemented method of claim 1, wherein:
the set of graduated evaluation metrics comprises graduation metrics that correspond to a positive predicted transaction, a neutral predicted transaction, and a negative predicted transaction;
the graduated evaluation metric corresponds to the positive predicted transaction; and
the graduated visual indicia comprises a graphic corresponding to the positive predicted transaction.

4. The computer implemented method of claim 1, wherein:
the popup window overlaps at least a portion of the web-based content displayed in the web browser application;
the popup window includes a selectable user interface element; and
in response to detecting an interaction with the selectable user interface element, displaying, in the web browser application, content associated with the purchase metric.

5. The computer implemented method of claim 4, wherein:
the selectable user interface element is a first selectable user interface element; and
causing the display of the popup window further comprises causing the display of a second selectable user interface element in the popup window that provides an option to save the listing to a set of saved listings associated with the user account.

6. The computer implemented method of claim 5, wherein:
causing the display of the popup window further comprises displaying a third selectable user interface element in the popup window, the third selectable user interface element providing an option to view the set of saved listings; and
in response to receiving a selection of the third selectable user interface element, launching a new browser window, the new browser window showing the set of saved listings including the listing.

7. The computer implemented method of claim 1, wherein making the determination that the content classifier corresponds to the listing page comprises comparing the uniform resource locator to a set of uniform resource locators associated with real estate listing sites.

8. The computer implemented method of claim 1, wherein the purchase metric indicates whether an estimated reoccurring cost associated with the listing is less than a current recurring cost of living for a user associated with the user account.

9. A computer implemented method for generating a personalized graduated evaluation metric for a listing being displayed in a web browser application and associated with a listing site, the method comprising:
authenticating a user account by receiving a set of login credentials at an authentication server and sending an authentication token associated with the set of login credentials to a browser extension operating in the web browser application;
obtaining a first set of listing data using the uniform resource locator for a web-based content being displayed by the browser extension, the first set of listing data comprising a listing price and a listing address;
using the first set of listing data, retrieving from one or more databases a second set of listing data associated with listing;
retrieving a set of user information associated with the user account,;
generating a purchase metric for the listing based on the first set of listing data, the second set of listing data, and the set of user information; and
selecting a graduated evaluation metric from a set of graduated evaluation metrics, each graduated evaluation metric in the set of graduated evaluation metrics associated with a respective threshold range, selecting the graduated evaluation metric based on the purchase metric satisfying the respective threshold range of the graduated evaluation metric; and
causing the browser extension to display a popup window containing a graduated visual indicia corresponding to the graduated evaluation metric.

10. The method of claim 9, wherein:
the second set of listing data comprises loan information associated with the listing; and
generating the purchase metric comprises computing a reoccurring cost for the user based on the second set of listing data.

11. The method of claim 10, further comprising computing a reoccurring cost for the listing based on the first set of listing data, wherein generating the purchase metric comprises computing the recurring cost for the listing.

12. The method of claim 9, wherein the set of graduated evaluation metrics comprise a positive evaluation metric corresponding to a first threshold range, a neutral evaluation metric corresponding to a second threshold range, and a negative evaluation metric corresponding to a third threshold range.

13. The method of claim 12, wherein:
the first threshold range corresponds to a value for the purchase metric indicating that a reoccurring cost associated with the listing is less than a current reoccurring cost of the user;
the second threshold range corresponds to the value for the purchase metric indicating that the recurring cost associated with the listing is substantially the same as the current reoccurring cost of the user; and
the third threshold range corresponds to the value for the purchase metric indicating that the recurring cost associated with the listing is greater than the current recurring cost of the user.

14. The method of claim 12, wherein the graduated visual indicia is selected from a set of visual indicia, the set of visual indicia comprising a first visual indicia corresponding to the positive evaluation metric, a second visual indicia corresponding to the neutral evaluation metric, and a third visual indicia corresponding to the negative evaluation metric.

15. The method of claim 9, wherein the authentication token comprises a Java Script Object Notation web token.

16. A computer implemented method for generating personalized graduated evaluation metrics for a listing contained on a listing site, the method comprising:
authenticating a first user account by receiving a first set of login credentials at an authentication server and sending a first authentication token associated with the first set of login credentials to a first browser extension operating in a first web browser application;
authenticating a second user account by receiving a second set of login credentials at the authentication server and sending a second authentication token associated with the second set of login credentials to a second browser extension operating in a second web browser application;
receiving a first set of listing data associated with web-based content for the listing, the first set of listing data comprising a listing price and a listing address;
using the first set of listing data, retrieving from one or more databases a second set of listing data associated with the first user account and a third set of listing data associated with the second user account;
retrieving a first set of user information associated with the first user account, the first set of user information comprising cost data associated with a current property of the first user account;
retrieving a second set of user information associated with the second user account, the second set of user information comprising cost data associated with a current property of the second user account;
generating a first graduated evaluation metric for the listing based on the first set of listing data, the second set of listing data, and the first set of user information;
generating a second graduated evaluation metric for the listing based on the first set of listing data, the third set of listing data, and the second set of user information;
causing the first web browser application to display a first popup window containing a first graduated visual indicia corresponding to the first graduated evaluation metric; and
causing the second web browser application to display a second popup window containing a second graduated visual indicia different from the first graduated visual indicia and corresponding to the second graduate evaluation metric.

17. The computer implemented method of claim 16, wherein:
the first graduated evaluation metric is determined by computing a first purchase metric for the listing and the first purchase metric satisfying a first threshold range;
the second graduated evaluation metric is determined by computing a second purchase metric for the listing and the second purchase metric satisfying a second threshold range.

18. The computer implemented method of claim 17, wherein:
the first graduated evaluation metric is different from the second graduated evaluation metric;
the first graduated visual indicia corresponds to the first graduated evaluation metric; and
the second graduated visual indicia corresponds to the second graduated evaluation metric.

19. The computer implemented method of claim 17, wherein the set of graduated evaluation metrics comprises a positive evaluation metric corresponding to a first threshold range, a neutral evaluation metric corresponding to a second threshold range, and a negative evaluation metric corresponding to a third threshold range.

20. The computer implemented method of claim 19, wherein:
the first graduated evaluation metric corresponds to the positive evaluation metric; and
the second graduated evaluation metric corresponds to the neutral evaluation metric.

21. A computer implemented method for generating a real-time personalized graduated evaluation metric associated with listings being displayed in a web browser application, the computer implemented method comprising operating a browser extension in the web browser application to perform steps of:
in response to receiving a set of login credentials in response to a user selecting a uniform resource locator link received in an electronic message:
authenticating a first user account associated with the set of login credentials;
receiving a first set of user information associated with the first user account; and
causing the browser extension to:
display a web-based content associated with a listing page:
obtain a first set of listing data by parsing text fields of the web-based content, the first set of listing data comprising a listing price and a listing address;
convert the first set of listing data from a first data format and to a second data format;
using the converted first set of listing data, retrieve from one or more databases a second set of listing data, the second set of listing data including loan information associated with a real estate item referenced on a listing;
generate a purchase metric for the listing based on the converted first set of listing data, the second set of listing data, and the first set of user information;
select a graduated evaluation metric from a set of graduated evaluation metrics, each evaluation metric in the set of graduated evaluation metrics associated with a respective threshold range, selecting the graduated evaluation metric based on the purchase metric satisfying the respective threshold range of the graduated evaluation metric; and
cause the web browser application to display a popup window containing a graduated visual indicia corresponding to the graduated evaluation metric.

22. The computer implemented method of claim 21, further comprising:
causing the popup window to display one or more input fields, each input field associated with a purchase metric;
in response to receiving a user input at an input field of the one or more input fields, updating the purchase metric based on a value associated with the user input; and
causing the web browser application to display an updated visual indicia corresponding to the updated evaluation metric.

23. The computer implemented method of claim 22, wherein the one or more input fields comprises a monthly budget value, a down payment value, an appreciation value, an estimated ownership duration or a combination thereof.

24. The computer implemented method of claim 22, further comprising:
causing the popup window to display an option to send listing data to a second user of the system; and
in response to a user selecting the option to send listing data to a second user, saving the current values for the one or more input fields and sending an adaptive evaluation summary to the second user in accordance with the saved current values.

25. The computer implemented method of claim 21, further comprising:
in response to generating the purchase metric, causing the web browser application to display the graduated visual indicia over visual elements displayed on the listing page; and
in response to a user input to the region of the listing page comprising the graduated visual indicia, causing the web browser application to display the popup window.
